(19) United States
(12) Patent Application Publication
(10) Pub. No.: US 2011/0030477 A1
(43) Pub. Date: Feb. 10, 2011

(54) ULTRASOUND INSPECTION METHOD AND APPARATUS

(75) Inventor: John Cousins, Bristol (GB)

Correspondence Address: LOWE HAUPTMAN HAM & BERNER, LLP, 1700 DIAGONAL ROAD, SUITE 300, ALEXANDRIA, VA, 22314, US

(73) Assignee: AIRBUS OPERATIONS LIMITED, Bristol (GB)

(21) Appl. No.: 12/936,738

(22) PCT Filed: Apr. 20, 2009
(86) PCT No.: PCT/GB09/50390

§ 371 Date: Oct. 7, 2010

(30) Foreign Application Priority Data
May 1, 2008 (GB) 0807955.0

(51) Int. Cl. G01N 29/28

(52) U.S. Cl. 73/589

(57) ABSTRACT

A method of inspecting a component, the component comprising a hole with an entrance. The method comprises: directing ultrasound into the component via a liquid coupling medium; receiving ultrasound from the component via the liquid coupling medium; and processing the received ultrasound to determine a property of the component. The entrance of the hole is sealed with tape to prevent the liquid coupling medium from flowing into the entrance of the hole.

The tape has an acoustic impedance within 40% of the acoustic impedance of the liquid coupling medium. By selecting a tape with an acoustic impedance relatively close to that of the liquid coupling medium (which in most cases will be water) the tape is relatively transparent to ultrasound and thus enables at least the presence or absence of a defect in a wall of the hole to be determined.

### FIELD OF THE INVENTION

The present invention relates to a method and apparatus for inspecting a component with ultrasound.

### BACKGROUND OF THE INVENTION

FIG. 1 shows a conventional method of inspecting a composite component 1 with a hole 2. The component 1 is immersed in a tank 3 containing water 4. Ultrasonic energy is emitted from a transducer 6 through the water 4 into the component 1. After passing through the component 1, the ultrasonic energy is directed off a reflector back through the component to the transducer 6. The received ultrasonic energy is processed by an ultrasonic measurement system (not shown) to build up a picture of the internal structure of the component.

A delamination defect 5 emanates from the hole 2. When the component 1 is placed in the tank 3, the water flows 4 into the hole 2 and fills the delamination defect 5. As a result the defect 5 becomes difficult to detect by the ultrasonic measurement system. For this reason, conventional ultrasonic immersion techniques can be unreliable for detecting such defects.

One conventional solution to this problem is to place the transducer in direct contact with the panel, thus removing the requirement of a liquid coupling medium. However this can be labour intensive and time consuming. Another conventional solution is to use a phased array ultrasound device, again in direct contact with the panel, thus removing the requirement of a liquid coupling medium. However, this can be expensive and requires a specially trained operator.

GB2292610 discloses an arrangement in which cracks can be detected in one or more sheets of material such as aluminium in the vicinity of a fastener hole through the sheet whilst the fastener remains in position in the hole.

U.S. Pat. No. 4,410,826 discloses an data acquisition head for an ultrasonic imaging system which employs a plurality of transducers. The transducers are rotated in a liquid filled chamber at a constant rate, each about an axis perpendicular to its transmission axis. The transducers are sequentially activated as their transmission axes cross a semi-rigid membrane which is in contact with the body. The acoustic impedance of the liquid and membrane, and the thickness of the membrane, are matched to enhance transmission.

In US2008/0053230 a bottom surface of a medium tank is closed with a polymer film, the polymer film is stuck to the medium tank by reducing the pressure of the inside of the medium tank, an ultrasonic wave transmission medium is injected while reducing the pressure of the inside of the medium tank so that the distal end of an ultrasonic probe is immersed, the inside of the medium tank is pressurized while keeping an inspection object in contact with the polymer film, and an ultrasonic wave reflected by the inspection object is received by the ultrasonic probe.

### SUMMARY OF THE INVENTION

A first aspect of the preset invention provides a method of inspecting a component, the component comprising a hole with an entrance, the method comprising: directing ultrasound into the component via a liquid coupling medium; receiving ultrasound from the component via the liquid coupling medium; processing the received ultrasound to determine a property of the component; and sealing the entrance of the hole with tape to prevent the liquid coupling medium from flowing into the entrance of the hole, wherein the tape has an acoustic impedance within 40% of the acoustic impedance of the liquid coupling medium.

A second aspect of the invention provides apparatus for inspecting a component, the component comprising a hole with an entrance, the apparatus comprising: an ultrasound measurement device; a tape for sealing the entrance of the hole, the tape having an acoustic impedance within 40% of the acoustic impedance of water (that is, the tape has an acoustic impedance within 40% of 1.49×10⁶ kg·s⁻¹·m⁻²); and an adhesive for adhering the tape to the surface of the component.

By selecting a tape with an acoustic impedance relatively close to that of the liquid coupling medium (which in most cases will be water) the tape is relatively transparent to ultrasound and thus enables at least the presence or absence of a defect in a wall of the hole to be determined.

Typically the tape has an acoustic impedance within 30% of the acoustic impedance of the liquid coupling medium. More preferably the tape has an acoustic impedance within 20% of the acoustic impedance of the liquid coupling medium.

Typically the tape has a longitudinal wave velocity within 40% of the longitudinal wave velocity of the liquid coupling medium, preferably within 30% and most preferably within 20%.

Typically the tape attenuates the ultrasound being directed into the component by less than 6 dB, preferably by less than 4 dB.

Typically the component is made of a laminate material such as a fibre-reinforced composite. The method can then be used to detect the presence or absence of delamination defects within the component, and particular delamination defects in a wall of the hole.

The hole may be a through-hole with two entrances, or a blind hole with only one entrance. In the case of a through-hole, both entrances are typically sealed with the tape.

### BRIEF DESCRIPTION OF THE DRAWINGS

Embodiments of the invention will now be described with reference to the accompanying drawings, in which:

FIG. 1 shows a component with a hole in a conventional ultrasonic immersion testing configuration;

FIG. 2 shows a component with a hole sealed with tape;

FIG. 3 shows a method of inspecting the component of FIG. 2; and

FIG. 4 shows an alternative method of inspecting the component of FIG. 2.

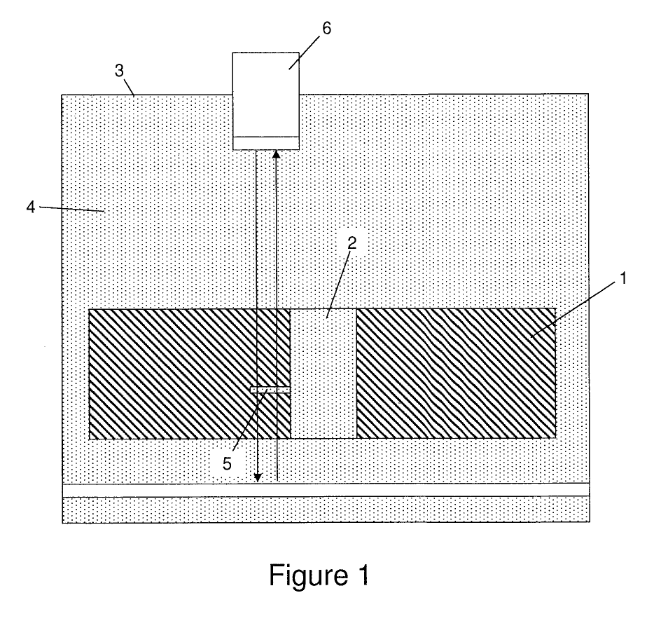

### DETAILED DESCRIPTION OF EMBODIMENT(S)

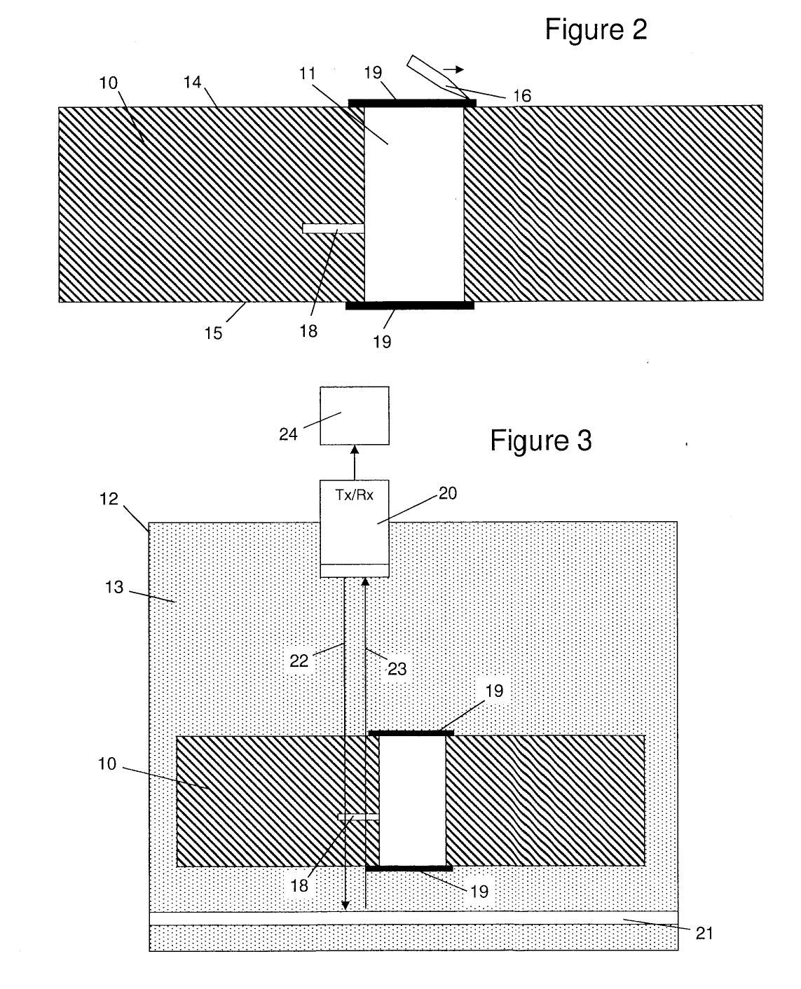

FIG. 2 shows a composite component 10 comprising a drilled hole 11 which passes vertically through the component 10, penetrating both its upper and lower surfaces 14, to produce upper and lower entrances. The component 10 is made from a Carbon Fibre Reinforced Plastic (CFRP) composite material, with plies of the material terminating at the hole 11. A delamination defect 18 is shown emanating from the side of the hole 11.

Tape 19 is applied to seal both the upper and lower entrances of the hole 11. The tape 19 is attached to the upper and lower surfaces 14, 15 of the composite component 10 with a thin layer of water resistant adhesive (not shown). The adhesive used to attach the tape 19 to the component 10 cures at room temperature, which makes the tape 19 easy to apply. After the tape 19 has been applied, a scraper 16 is scraped across it as shown in FIG. 2 to remove air bubbles. The scraper 16 is transparent to enable any air bubbles to be seen by an operator.

Next the component 10 is immersed in a water tank 12 as shown in FIG. 3, the tape 19 preventing the water 13 from entering the hole 11 through either the upper or lower entrances.

Ultrasound energy 22 is emitted from an ultrasound transducer 20 and directed into the component 10 via the water 13. After passing through the component 10, the energy is reflected by a glass reflector plate 21 back through the component 10 and the water 13 to the ultrasound transducer 20. The received ultrasound 23 is then processed by a measurement system 24 to determine a property of the component 10.

The transducer 20 transmits a short pulse of ultrasound energy and receives a series of reflected pulses caused by: a) reflection from the front face of the component; b) reflection from any defects within the component; c) reflection from the rear face of the component; and d) reflection from the plate 21. The system 24 may analyse these pulses in a number of ways. For instance the system 24 may measure the time of arrival of the pulse b) from a defect within the component. This gives information on the presence or absence of a defect, and its depth within the component. Alternatively the amplitude of the pulse d) may be measured. Since this pulse has passed twice through the component, its amplitude gives an indication of the total attenuation loss through the component and hence an indication of the presence or absence of defects. The transducer is scanned in a raster pattern parallel to the component to build up a two-dimensional image of the component. Typically the data is presented as a colour image where the colour of each pixel gives either the depth of a defect, or the attenuation loss through the component.

The water 13 in the tank 12 acts as a coupling medium through which the ultrasonic energy can flow with relatively low and uniform attenuation. As the tape 19 prevents the water 13 from flowing into the hole 11, the delamination defect 18 is filled with air. Air has a substantially greater acoustic impedance than both the water coupling medium and the composite material of the component 10. Thus, the ultrasound is attenuated more severely when it passes through the defect 18. This enables the defect 18 to be discriminated from its surroundings by the measurement system 24.

The combination of the adhesive layer and the tape 19 attenuates the ultrasound 22 being directed into the component by less than 6 dB (and preferably by less than 4 dB) in each direction. This allows a sufficient quantity of ultrasonic energy to be returned to the transducer 20 to enable inspection of the internal structure of the component within the taped region.

The tape 19 and the adhesive are made from materials which have acoustic impedances similar to that of water (which has an acoustic impedance of 1.49×10⁶ rayl=1.49×10⁶ kg·s⁻¹·m⁻²). This is beneficial as little or no extra work is required to take account of the tape 19 or the adhesive in the interpretation of the ultrasonic images generated by the measurement system.

For the tape, a material such as NUWC XP-1 polyurethane urea; PRC-Desoto's PR-1547 or PR-1592; or Cytech's Conathane EN-7 are suitable. These have acoustic impedances around 1.71×10⁶ rayl—that is, approximately 15% higher than that of water. It is expected that this tape material will introduce an attenuation loss lower than 3 dB in each direction.

The tape is manufactured by a simple extrusion process or by a calendaring process.

The adhesive is applied to the tape by spraying or dipping. For the adhesive, materials such as Epoxy Adhesive DP-190 are suitable. Because only a thin layer of adhesive is needed to bond the tape to the component, the acoustic impedance of the adhesive is not critical.

Preferably the tape 19 also has a similar longitudinal wave velocity to that of water (which is 1430 m/s). This allows the measurement system to employ a time of flight algorithm (such as the pulse-echo technique) to process the received ultrasonic signals without the need to introduce additional measurement compensations.

NUWC XP-1 polyurethane urea, PRC-Desoto's PR-1547 and PR-1592 and Cytech's Conathane EN-7 have densities which are all comparable to that of pure water at room temperature (for example PR 1547 has a density of 1.05 g/cm³ compared to water which is 1 g/cm³). As acoustic impedance is calculated as (density×velocity) then it can be seen that these materials have longitudinal wave velocities that are comparable to that of water.

Although a double-pass through transmission ultrasound measurement system is shown in FIG. 3, other measurement modes could be employed including a single-pass through transmission technique.

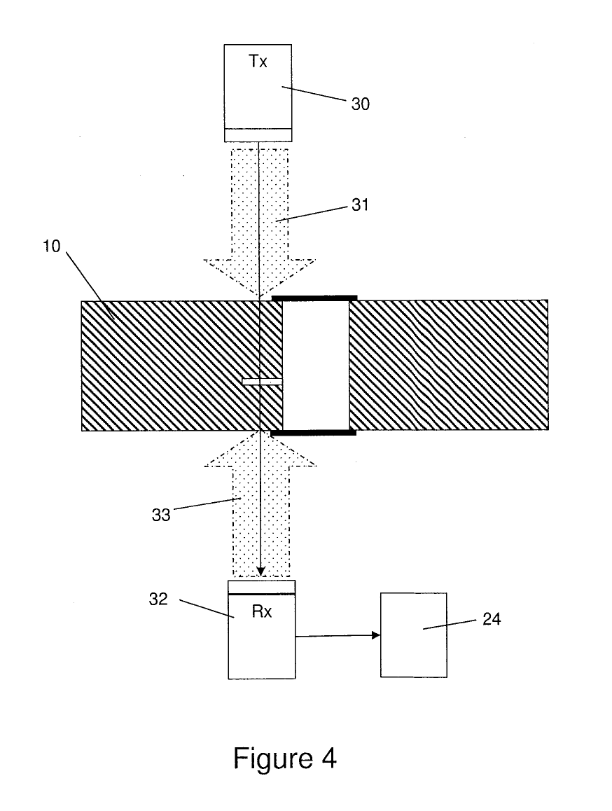

Moreover, the water path providing the coupling between the ultrasound transducer 20 and the component 10 may be provided by squirting a jet of water onto the component instead of fully immersing the component in water. An example is shown in FIG. 4 in which a transmitter 30 directs ultrasound into the component via a water jet 31 spraying onto the component from above, and a receiver 32 receives ultrasound from the component via a water jet 33 spraying onto the component from below.

Although a water coupling medium is used in the examples described, any other suitable liquid coupling medium could be used. In this case the tape and adhesive are preferably chosen to have a similar acoustic impedance and longitudinal wave velocity to that of the alternative coupling medium.

Although the invention has been described above with reference to one or more preferred embodiments, it will be appreciated that various changes or modifications may be made without departing from the scope of the invention as defined in the appended claims.

1. A method of inspecting a component, the component comprising a hole with an entrance, the method comprising:
a. directing ultrasound into the component via a liquid coupling medium;
b. receiving ultrasound from the component via the liquid coupling medium;
c. processing the received ultrasound to determine a property of the component; and
d. sealing the entrance of the hole with tape to prevent the liquid coupling medium from flowing into the entrance of the hole, wherein the tape has an acoustic impedance within 40% of the acoustic impedance of the liquid coupling medium.

2. The method of claim 1 wherein the tape has an acoustic impedance within 30% of the acoustic impedance of the liquid coupling medium.

3. The method of claim 1 wherein the tape has an acoustic impedance within 20% of the acoustic impedance of the liquid coupling medium.

4. The method of claim 1 wherein the tape has a longitudinal wave velocity within 40% of the longitudinal wave velocity of the liquid coupling medium.

5. The method of claim 1 wherein the tape has a longitudinal wave velocity within 30% of the longitudinal wave velocity of the liquid coupling medium.

6. The method of claim 1 wherein the tape has a longitudinal wave velocity within 20% of the longitudinal wave velocity of the liquid coupling medium.

7. The method of claim 1 wherein the tape attenuates the ultrasound being directed into the component by less than 6 dB.

8. The method of claim 1 where the tape is adhered to the surface of the component with adhesive.

9. The method of claim 8 wherein the adhesive is an epoxy resin which cures at room temperature.

10. The method of claim 1 wherein the component is made of a laminate material.

11. The method of claim 1 wherein the received ultrasound is processed to determine the presence or absence of a defect in a wall of the hole.

12. Apparatus for inspecting a component, the component comprising a hole with an entrance, the apparatus comprising:
a. an ultrasound measurement device; characterized in that the apparatus further comprises
b. a tape (19) for sealing the entrance of the hole, the tape having an acoustic impedance within 40% of the acoustic impedance of water (1.49×10⁶ kg·s⁻¹·m⁻²); and
c. an adhesive for adhering the tape to the surface of the component.

13. The apparatus of claim 12 wherein the tape has an acoustic impedance within 30% of the acoustic impedance of water (1.49×10⁶ kg·s⁻¹·m⁻²).

14. The apparatus of claim 13 wherein the tape has an acoustic impedance within 20% of the acoustic impedance of water (1.49×10⁶ kg·s⁻¹·m⁻²).
